(19) United States
(12) Patent Application Publication
(10) Pub. No.: US 2023/0214538 A1
(43) Pub. Date: Jul. 6, 2023

(54) CONTROL DEVICE AND ACCESS METHOD

(71) Applicant: Nuvoton Technology Corporation, Hsinchu Science Park (TW)

(72) Inventor: Chia-Yang LIANG, Tainan City (TW)

(21) Appl. No.: 18/092,001

(22) Filed: Dec. 30, 2022

(30) Foreign Application Priority Data
Dec. 30, 2021 (TW) 110149579

(51) Int. Cl. G06F 21/79; G06F 21/75

(52) U.S. Cl. CPC G06F 21/79; G06F 21/75

(57) ABSTRACT

A control device is provided, in which the control device is coupled to an external memory and includes a storage circuit, a memory mapping circuit, and a central processing unit (CPU). The storage circuit stores a firmware image. The memory mapping circuit divides the firmware image into a plurality of segments and calculates the start address of each of the segments and the identifier code to generate an access sequence. The CPU reads the storage circuit and outputs the segments to the external memory according to the access sequence.

### CROSS REFERENCE TO RELATED APPLICATIONS

This Application claims priority of Taiwan Patent Application No. 110149579, filed on Dec. 30, 2021, the entirety of which is incorporated by reference herein.

### BACKGROUND OF THE INVENTION

### Field of the Invention

The invention relates to a control device, and more particularly to a control device that writes data to an external memory.

### Description of the Related Art

For some chips with lower computing power, these chips usually do not have an encryption function, so they cannot encrypt and protect the data in an external memory. Therefore, the data stored in the external memory can easily be stolen.

### BRIEF SUMMARY OF THE INVENTION

In accordance with an embodiment of the disclosure, a control device is coupled to an external memory and comprises a storage circuit, a memory mapping circuit, and a central processing unit (CPU). The storage circuit stores a firmware image (referred to as program codes). The memory mapping circuit divides the firmware image into a plurality of segments and calculates a start address of each of the segments and an identifier code to generate an access sequence. The CPU reads the storage circuit and outputs the segments to the external memory according to the access sequence.

An access method for accessing an external memory is provided. An exemplary embodiment of the access method is described in the following paragraph. A firmware image is stored. The firmware image is divided into a plurality of segments. The start address of each of the segments and an identifier code are calculated to generate an access sequence. The segments are written to the external memory in the access sequence.

Methods for accessing an external memory may be practiced by the control device which have hardware or firmware capable of performing particular functions and may take the form of program code embodied in a tangible media. When the program code is loaded into and executed by an electronic device, a processor, a computer or a machine, the electronic device, the processor, the computer or the machine becomes the control device for practicing the disclosed method.

### BRIEF DESCRIPTION OF THE DRAWINGS

The invention can be more fully understood by referring to the following detailed description and examples with references made to the accompanying drawings, wherein:

FIG. 1 is an operation schematic diagram of an exemplary embodiment of a scatter device according to various aspects of the present disclosure.

FIG. 2 is a schematic diagram of an exemplary embodiment of the scatter device according to various aspects of the present disclosure.

FIG. 3 is a flowchart of an exemplary embodiment of an access method according to various aspects of the present disclosure.

### DETAILED DESCRIPTION OF THE INVENTION

The present invention is described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

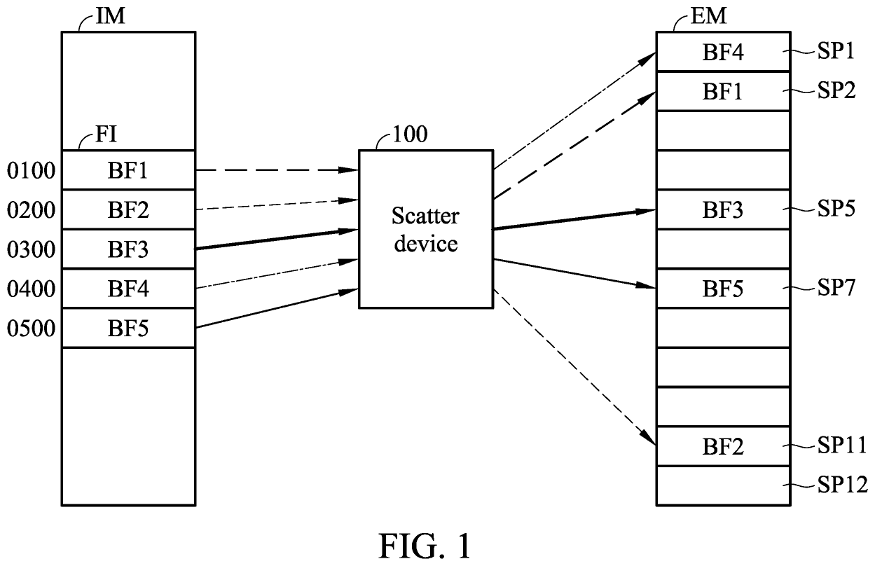

FIG. 1 is an operation schematic diagram of an exemplary embodiment of a scatter device according to various aspects of the present disclosure. The scatter device 100 divides the firmware image FI into segments BF1˜BF5 and scatters the arrangement sequence of the segments BF1˜BF5. Then, the scatter device 100 sorts the scattered result to generate an access sequence. Next, the scatter device 100 writes the segments BF4, BF1, BF3, BF5, and BF2 to an external memory EM according to the access sequence. In this embodiment, the arrangement sequence of the segments stored in the external memory EM is different from the arrangement sequence of the segments of the firmware image FI.

The kind of external memory EM is no limited in the present disclosure. In one embodiment, the external memory EM is a flash memory. In this embodiment, the external memory EM comprises storage spaces SP1˜SP12, but the disclosure is not limited thereto. In other embodiments, the external memory EM comprises more or fewer storage spaces. In this embodiment, the storage space SP1 stores the segment BF4, the storage space SP2 stores the segment BF1, the storage space SP5 stores the segment BF3, the storage space SP7 stores the segment BF5, the storage space SP11 stores the segment BF2.

In one embodiment, the scatter device 100 appoints a first storage space (e.g., SP1) of the external memory EM as a start space and appoints a second storage space (e.g., SP11) of the external memory EM as an end space. In this case, the scatter device 100 stores the segments BF1˜BF5 in the idle storage spaces between the storage spaces SP1˜SP11.

In this embodiment, the scatter device 100 rearranges the arrangement sequence of the segments BF1˜BF5 stored in the storage circuit IM. The scatter device 100 does not change the value of the data stored in each segment and the arrangement sequence of the data stored in each segment. Taking the segment BF1 as an example, assume that the value of the data stored in segment BF1 is 1110 0101 0000 1111. In this case, when the segment BF1 is written into the storage space SP2 of the external memory EM, the scatter device 100 does not change the arrangement sequence of the value of the data stored in the segment BF1. Therefore, the arrangement sequence of the value of the data stored in the storage space SP12 is 1110 0101 0000 1111.

The number of segments is not limited in the present disclosure. In other embodiments, the scatter device 100 may divide the firmware image FI into more or fewer segments. In one embodiment, the scatter device 100 determines the size of each segment according to the size of the firmware image FI. For example, when the size of the firmware image FI is larger than a predetermined value, the size of each segment is 16KB (kilo bytes). When the size of the firmware image FI is not larger than the predetermined value, the size of each segment is 8KB.

In another embodiment, the scatter device 100 determines the size of each segment according to an external set. In this case, the scatter device 100 may determine the size of the firmware image FI according to the external set. In some embodiments, the scatter device 100 determines the size of each segment according to the size of the blocks of the external memory EM. In this embodiment, the storage spaces SP1˜SP12 are twelve blocks of the external memory EM.

The source of the firmware image FI is not limited in the present disclosure. In one embodiment, the firmware image FI is stored in a storage circuit IM. The storage circuit IM may be a volatile memory, such as a dynamic random access memory (DRAM). In some embodiments, the storage circuit IM may be integrated witch the scatter device 100 in a chip.

In this embodiment, the arrangement sequence (BF4, BF1, BF3, BF5, and BF2) of the segments of the external memory EM is different from the arrangement sequence (BF1, BF2, BF3, BF4, and BF5) of the segments of the storage circuit IM. Therefore, even if the external memory EM is illegally accessed, the external illegal person cannot determine the correction firmware image FI. Therefore, the security of the firmware image FI is improved. In some embodiments, the external memory EM may be a non-volatile memory.

The present disclosure does not limit how the scatter device 100 scatters the segments BF1˜BF5. In one embodiment, the scatter device 100 uses an algorithm to calculate the start addresses (e.g., 0100, 0200, 0300, 0400, and 0500) of the segments BF1˜BF5 in the storage circuit IM with an identifier code to determine five calculation results (e.g., 02, 05, 03, 01, and 04). The scatter device 100 generates an access sequence according to the calculation results. The scatter device 100 successively outputs the segments BF4, BF1, BF3, BF5, and BF2 to the external memory EM according to the access sequence. In some embodiments, the identifier code is the universally unique identifier (UUID) of the chip comprising the scatter device 100. Since different chips comprise different UUIDs, when the scatter device 100 is integrated into different chips, the scatter device 100 generates different access sequences for the same firmware image FI.

In other embodiments, the scatter device 100 records the start addresses of the segments BF1˜BF5 in the storage circuit IM and the arrangement sequence (referred to as an access sequence) of the segments in the external memory EM. When the scatter device 100 receives a loading command (not shown), the scatter device 100 decodes the loading command to determine a read address (e.g., 0200) and determines the corresponding segment (e.g., BF2). Therefore, the scatter device 100 reads the storage space SP11 of the external memory EM to read the segment BF2 in the external memory EM.

In another embodiment, the scatter device 100 further records the original sequence of the segments in the storage circuit IM and the access sequence in which the segments are written into the external memory EM. In this case, the scatter device 100 reads the storage spaces SP1, SP2, SP5, SP7, and SP11 in the external memory EM to obtain the segments BF4, BF1, BF3, BF5, and BF2 in order. Then, the scatter device 100 rearranges the segments BF4, BF1, BF3, BF5, and BF2 according to the mapping relationship between the original sequence and the access sequence. After rearranging the segments BF4, BF1, BF3, BF5, and BF2, the sequence of the segments is BF1, BF2, BF3, BF4, and BF5. The scatter device 100 may store the rearranged segments in a third storage circuit. In this case, the arrangement sequence of the segments in the third storage circuit is the same as the arrangement sequence of the segments in the storage circuit IM.

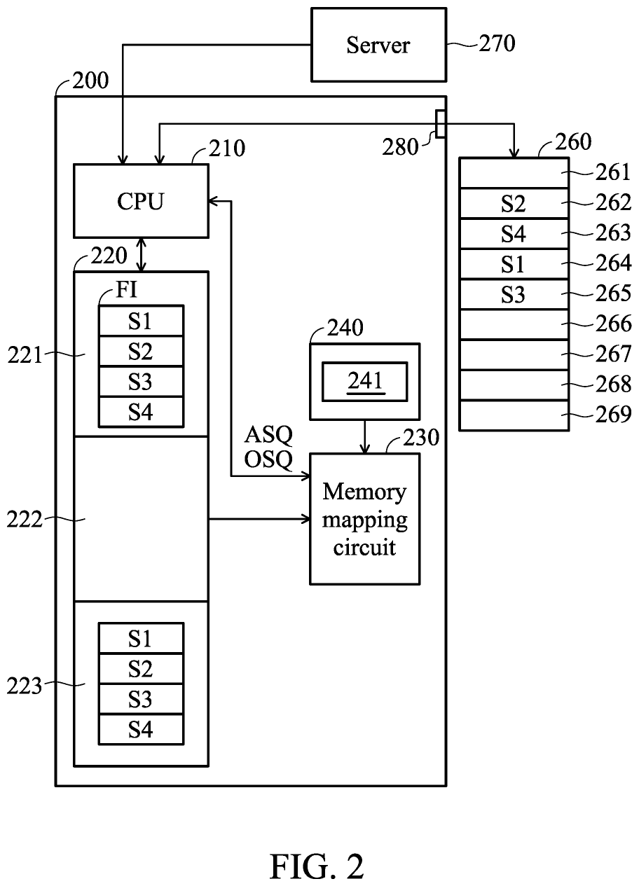

FIG. 2 is a schematic diagram of an exemplary embodiment of the scatter device according to various aspects of the present disclosure. In this embodiment, the scatter device is combined into the control device 200. The kind of control device 200 is not limited in the present disclosure. In one embodiment, the control device 200 is a micro-controller unit (MCU). In this embodiment, the control device 200 is coupled to an external memory 260 and comprises a central processing unit (CPU) 210, a storage circuit 220, and a memory mapping circuit 230.

In some embodiments, the control device 200 is further coupled to a server 270. The control device 200 downloads the firmware image FI from the server 270. The control device 200 may utilize a line (e.g., a network line) or a wireless method (e.g., Wi-Fi) to couple to the server 270. In one embodiment, the server 270 is a web server.

The CPU 210 is coupled to the server 270 to download the firmware image FI and stores the firmware image FI in a block 221 in the storage circuit 220. In this embodiment, the storage circuit 220 comprises blocks 221˜223, but the disclosure is not limited thereto. In other embodiments, the storage circuit 220 comprises more or fewer blocks. Additionally, the type of storage circuit 220 is not limited in the present disclosure. In one embodiment, the storage circuit 220 is a volatile memory, such as a DRAM. In other embodiments, the CPU 210 receives an upgrade image and stores the upgrade image to the block 221 to replace the original firmware image FI.

The memory mapping circuit 230 divides the firmware image FI into segments S1˜S4 and calculates the start address of each of the segments S1˜S4 in the storage circuit 220 with identifier code 241 to generate an access sequence ASQ. In one embodiment, the identifier code 241 is the UUID of the control device 200. In some embodiments, the calculation performed by the memory mapping circuit 230 comprises one or a combination of a XOR operation, an OR operation, an addition operation, and a subtraction operation.

In other embodiments, the control device 200 further comprises a storage circuit 240. The storage circuit 240 is configured to store the identifier code 241. The type of storage circuit 240 is not limited in the present disclosure. The storage circuit 240 may be a non-volatile memory.

When the CPU 210 receives a write command or a burn command, the CPU 210 reads the storage circuit 220 to determine the segments S1˜S4. Then, the CPU 210 changes the arrangement sequence of the segments S1˜S4 according to the access sequence ASQ. For example, the arrangement sequence of the segments S1—S4 is changed from S1->S2->S3->S4 to S2->S4->S1->S3. The CPU 210 outputs the segments S2, S4, S1, and S3 to the external memory 260 in order. In this embodiment, the external memory 260 at least comprises storage spaces 261˜269. In this case, the segments S2, S4, S1, and S3 store in the storage spaces 262˜267 respectively. Since the characteristics of the external memory 260 shown in FIG. 2 are similar to the characteristics of the external memory EM shown in FIG. 1, the description thereof is not repeated herein.

In one embodiment, the memory mapping circuit 230 records the arrangement sequence (referred to as the original sequence OSQ) of the segments S1˜S4 in the storage circuit 220. In this case, when the CPU 210 is ready to perform the firmware image FI, the CPU 210 reads the external memory 260 according to the access sequence ASQ to generate a read result, such as S2->S4->S1->S3. The CPU 210 rearranges the segments of the read result (e.g., S2->S4->S1->S3) according to the mapping relationship between the original sequence OSQ and the access sequence ASQ. Then, the CPU 210 stores the rearranged result (S1->S2->S3->S4) in the block 223 of the storage circuit 220. In this case, the arrangement sequence of the segments in the block 223 is the same as the arrangement sequence of the segments in the block 221. Then, the CPU 210 performs the program codes of the segments S1˜S4 in the block 223.

In other embodiments, the CPU 210 disallows the device other than the control device 200 to access the storage circuit 240. In some embodiments, the CPU 210 performs a security operation to prevent an external circuit from reading the identifier code 241.

In another embodiment, the control device 200 further comprises a communication interface 280. The communication interface 280 is coupled between the CPU 210 and the external memory 260. The CPU 210 accesses the external memory 260 via the communication interface 280. The kind of communication interface 280 is not limited in the present disclosure. In one embodiment, the communication interface 280 is a serial peripheral interface (SPI).

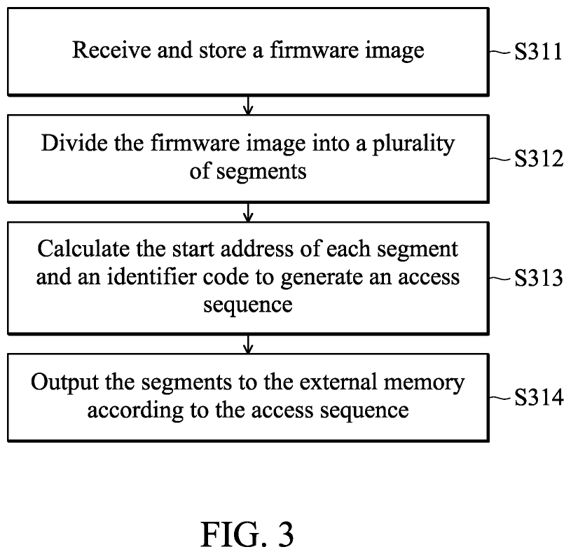

FIG. 3 is a flowchart of an exemplary embodiment of an access method according to various aspects of the present disclosure. The access method is utilized to access an external memory. First, a firmware image is received and stored (step S311). In one embodiment, the firmware image is stored in a first storage circuit. The arrangement sequence of the segments constituting the firmware image is referred to as the original sequence.

The firmware image is divided into a plurality of segments (step S312). In one embodiment, the size of each segment and the number of segments are related to the size of the firmware image. For example, the size of each segment is increased incrementally as the size of the firmware image increases. In another embodiment, the size of each segment is related to the size of each block of the external memory. Furthermore, step S312 is also performed to receive an external set and determine the size of each segment according to the external set.

The start address of each segment and an identifier code are calculated to generate an access sequence (step S313). In one embodiment, step S313 is to perform one or a combination of a XOR operation, an OR operation, an addition operation and a subtraction operation. In other embodiments, the identifier code is stored in a second storage circuit. The second storage circuit may be a non-volatile memory.

The segments are written to the external memory according to the access sequence (step S314). In one embodiment, step S314 is to output the segments to the external memory in serial. In this embodiment, the arrangement sequence (referred to as the access sequence) of the segments in the external memory is different from the arrangement sequence (referred to as the original sequence) of the segments in the first storage circuit. However, the arrangement sequence of data in each segment does not be changed. Taking FIG. 1 as an example, the arrangement sequence of data of the segment BF1 of the storage circuit IM is the same as the arrangement sequence of data of the segment BF1 of the external memory EM.

In other embodiments, the access method shown in FIG. 3 further comprises a loading step (not shown). The loading step is to receive an external address and then read the segments in the external memory according to the access sequence to determine the segments corresponding to decoded addresses. Taking FIG. 1 as an example, assume that the external address is 0100. The loading step is to find that the segment BF1 corresponds to the external address. Then, the loading step is to find that the segment BF1 is stored in the storage space SP2. Therefore, the loading step is to read the storage space SP2 to acquire the segment BF1.

In some embodiments, the loading step may be to read the program codes of the segments in the external memory and rearrange the segments into their original sequence (i.e., the arrangement sequence of the segments in step S312). Taking FIG. 1 as an example, the loading step is to read the segments BF4, BF1, BF3, BF5, and BF2 in the external memory and rearrange the segments BF4, BF1, BF3, BF5, and BF2 into their original sequence (i.e., the arrangement sequence of the segments BF1˜BF5 in the storage circuit IM). Then, the loading step is to store the rearranged result (BF1˜BF5) in a third storage circuit. The third storage circuit may be disposed independently of the first storage circuit. In some embodiments, the third storage circuit is a block in the first storage circuit. For example, the first storage circuit comprises a first block and a second block. In this case, the first block stores the firmware image, and the second block stores the rearranged result (BF1˜BF5).

In other embodiments, the access method shown in FIG. 3 further performs a security operation to prevent an external circuit from reading the identifier code. In this case, the identifier code is stored in a chip, and the external circuit is disposed independently of the chip.

It should be understood that when an element or layer is referred to as being “coupled to” another element or layer, it can be directly connected or coupled to the other element or layer or intervening elements or layers may be present. In contrast, when an element or layer is referred to as be “connected to” another element or layer, there are no intervening elements or layers present.

Access methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes a control device or a memory mapping circuit for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes a control device or a memory mapping circuit for practicing the disclosed methods. When implemented on a general-purpose processor, the program code combines with the processor to provide a unique apparatus that operates analogously to application-specific logic circuits.

Unless otherwise defined, all terms (including technical and scientific terms) used herein have the same meaning as commonly understood by one of ordinary skill in the art to which this invention belongs. It should be further understood that terms, such as those defined in commonly used dictionaries, should be interpreted as having a meaning that is consistent with their meaning in the context of the relevant art and will not be interpreted in an idealized or overly formal sense unless expressly so defined herein. It should be understood that, although the terms “first,” “second,” etc. may be used herein to describe various elements, these elements should not be limited by these terms. These terms are only used to distinguish one element from another.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control device coupled to an external memory and comprising:
a first storage circuit storing a firmware image;
a memory mapping circuit dividing the firmware image into a plurality of segments and calculating a start address of each of the segments and an identifier code to generate an access sequence; and
a central processing unit (CPU) reading the first storage circuit and outputting the segments to the external memory according to the access sequence.

2. The control device as claimed in claim 1, further comprising:
a second storage circuit storing the identifier code.

3. The control device as claimed in claim 1, further comprising:
a communication interface coupled between the CPU and the external memory to output the segments to the external memory.

4. The control device as claimed in claim 1, wherein in the first storage circuit, an arrangement sequence of the segments is the same as an original sequence, in the external memory, the arrangement sequence of the segments is the same as the access sequence which is different from the original sequence.

5. The control device as claimed in claim 4, wherein the CPU reads the segments stored in the external memory according to the access sequence to generate a read result, arranges the segments in the read result according to the original sequence, and then stores the arranged segments in the first storage circuit.

6. The control device as claimed in claim 5, wherein the first storage circuit is a volatile memory.

7. The control device as claimed in claim 1, wherein the CPU notifies the memory mapping circuit about the size of the firmware image, and the memory mapping circuit determines the size of the segments according to a set value.

8. The control device as claimed in claim 7, wherein the CPU generates the set value according to an external set.

9. The control device as claimed in claim 1, wherein:
a specific segment of the segments in the first storage circuit has a plurality of specific data, and the arrangement sequence of the specific data is a specific sequence, and
in response to the CPU writing the specific segment to the external memory, the arrangement sequence of the specific data of the specific segment in the external memory is the specific sequence.

10. The control device as claimed in claim 1, wherein the CPU performs a security operation to prevent an external circuit from reading the identifier code, and the external circuit is disposed independently from the control circuit.

11. A method for accessing an external memory, the method comprising:
storing a firmware image;
dividing the firmware image into a plurality of segments;
calculating a start address of each of the segments and an identifier code to generate an access sequence; and
writing the segments in the access sequence to the external memory.

12. The method as claimed in claim 11, wherein the segments are serially output to the external memory.

13. The method as claimed in claim 11, wherein the firmware image is stored in a storage circuit, the arrangement sequence in which the segments are written to the storage circuit is an original sequence, the arrangement sequence in which the segments are written to the external memory is the access sequence, and the access sequence is different from the original sequence.

14. The method as claimed in claim 13, wherein a specific segment among the segments in the storage circuit has a plurality of specific data, the arrangement sequence of the specific data is a specific sequence, and the arrangement sequence of the specific data in the external memory is the specific sequence.

15. The method as claimed in claim 13, further comprising:
reading the external memory according to the original sequence; and
writing the segments from the external memory back to the storage circuit.

16. The method as claimed in claim 11, further comprising:
determining the size of each segment according to the size of the firmware image.

17. The method as claimed in claim 11, further comprising:
receiving an external set; and
determining the size of each segment according to the external set.

18. The method as claimed in claim 11, further comprising:
performing a security operation to prevent an external circuit from reading the identifier code,
wherein the identifier code is stored in a chip, and the external circuit is disposed independently of the chip.
